(19) United States
(12) Patent Application Publication
(10) Pub. No.: US 2006/0045700 A1
(43) Pub. Date: Mar. 2, 2006

(54) Vehicle weighing system

(75) Inventors: Philippus Maria Antonius Siebers, Stramproy (NL); Maxim Wilhelmus Josefus Hartman, Apeldoorn (NL); Antonie Cornelis Pruim, Zwolle (NL); Heinrich Johannes Elbrink, Emmeloord (NL)

Correspondence Address: FOLEY & LARDNER LLP, 777 EAST WISCONSIN AVENUE, SUITE 3800, MILWAUKEE, WI, 53202-5308, US

(73) Assignee: Oshkosh Truck Corporation

(21) Appl. No.: 10/997,782

(22) Filed: Nov. 24, 2004

Related U.S. Application Data
(63) Continuation-in-part of application No. 10/910,252, filed on Aug. 2, 2004.

(51) Int. Cl. B60P 1/00

(52) U.S. Cl. 414/509

(57) ABSTRACT

A system for attaching a material container to different vehicles and measuring a load on the vehicles, each of the vehicles having chassis members. The system comprises a hydraulic system configured to control operation of the material container, a control system configured to control the hydraulic system, and a load indication system configured to measure the load on the vehicles, wherein the load indication system is operably connected to the control system to provide load information for controlling the hydraulic system and material container.

### CROSS-REFERENCE TO RELATED PATENT APPLICATIONS

This application is a continuation-in-part application of co-pending U.S. application Ser. No. 10/910,252 filed on Aug. 2, 2004, from which priority is claimed under 35 U.S.C. § 120. The full disclosure, in its entirety, of U.S. application Ser. No. 10/910,252 is hereby incorporated by reference.

### FIELD

The present invention relates to vehicles for hauling materials. In particular, the present invention relates to refuse hauling vehicles, such as rear loaders, which are equipped with a weighing system between the material (e.g., refuse) container and the chassis to monitor and control the distribution of weight of the refuse during collection.

### BACKGROUND

Many material handling containers which are mounted on heavy trucks require a sub frame which is attached to the frame rails of the truck chassis. For example, the refuse bodies for garbage trucks and waste hauling trucks are mounted upon a sub frame which is attached to the frame rails of the associated truck. Similarly, dump truck boxes may include sub frames mounted to the frame rails of the truck to support the dump box. Typically, the sub frame is utilized to provide an appropriate support for the associated material body. This support serves to prevent deformation and damage to the body when the vehicle chassis deforms (e.g. twisting of the frame rails relative to each other) during vehicle operation. The sub frame can also be mounted on the vehicle frame to help reduce frame deformation.

Referring to the truck chassis, in many commercial transactions for waste hauling trucks, the manufacturers of material handling containers are not the manufacturers of the truck chassis. For example, many municipalities waste management companies dictate the chassis manufacturer of the truck chassis to be used with a particular container or refuse body. Examples of truck chassis manufacturers include DAF, IVECO, Volvo, Scania, Mercedes-Benz, Dennis Eagle Ltd., MAN, Renault, and Seddon Atkinson. A major problem encountered by container and waste body manufacturers is the differences in the frames of the truck chassis sold by various suppliers. More specifically, the distance between chassis frame rails, the rigidity of the frames and the shape of the frame rails varies between supplier. As a result, the manufacturers of bodies are required to manufacture a different sub frame for every different chassis demanded by its material container customers.

To compound these problems, container load or weight monitoring is becoming a requirement for waste hauling trucks. In particular, the weight and change in weight of the container is monitored by locating electronic load cells between the waste body and the sub frame. With this arrangement, the load cells are in a position to generate signals representative of the weight of the waste body and contents on demand. However, the interpositioning of load cells between the sub frame and bodies increases the height of the body which increases the access height for loading and unloading the body. Additionally, the increased height raises the center of gravity of the overall vehicle which reduces the stability of the vehicle. Another problem is that the increased height may result in driving limitations in countries and other locations that impose height restrictions for certain vehicles. Further, an increased height can sometimes lead to problems in actually lifting a container.

With respect to rear loaded collection vehicles, refuse is often collected and compacted at the rear of the container and then moved slowly forward toward the front of the container (and vehicle). The refuse is compacted against a push-out panel which provides a counter pressure against the refuse and is controlled by a cylinder and hydraulic valves. When the counter pressure reaches a set level, the hydraulic valve opens so that the push-out panel can move forward. Thus, during collection, the container is first filled at the rear of the container. Refuse is pushed forward during collection. This often results in the rear axle becoming overloaded before the container is completely filled. Overloading of an axle can result in significant penalties in certain countries and regions of the United States.

In view of these problems, it would be desirable to provide a sub frame where all or substantially all of the components thereof could be universally used with a broad range of different truck chassis. Additionally, it would be desirable to provide an arrangement which permits the use of load cells without increasing the height of the associated material container the full height of the load cell. Further, it would be desirable to provide a total weighing system for monitoring the total weight on a vehicle as well the load at one or more individual axel.

It would be advantageous to provide a system or the like of a type disclosed in the present application that provides any one or more of these or other advantageous features. The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE DRAWINGS

FIG. 1A is a side view of a front and rear sub assembly coupled to a vehicle chassis and container comprising a weighing system according to an exemplary embodiment.

FIG. 1B is a side view of a front and rear sub assembly coupled to a vehicle chassis and container comprising a weighing system according to an exemplary embodiment.

FIG. 2 is a side view of a vehicle and container comprising a weighing system according to an exemplary embodiment.

FIG. 3 is a front perspective view of a front and rear sub assembly coupled to a vehicle chassis according to an exemplary embodiment.

FIG. 4 is a front perspective view of a rear sub assembly coupled to a vehicle chassis according to an exemplary embodiment.

FIG. 5 is an exploded front perspective view of the rear sub assembly according to an exemplary embodiment.

FIG. 6 is a front perspective view of a front sub assembly coupled to a vehicle chassis according to an exemplary embodiment.

FIG. 7 is an exploded front perspective view of the front sub assembly according to an exemplary embodiment.

FIG. 8 is a lower perspective view of a mounting system according to an exemplary embodiment.

FIG. 9 is an exploded lower perspective view of the mounting system according to an exemplary embodiment.

FIG. 10 is side view of the mounting system coupled to a container according to an exemplary embodiment.

FIG. 11 is a bottom plan view of the mounting system coupled to a container according to an exemplary embodiment.

FIG. 12 is a lower perspective view of a rear sub frame coupled to a container according to an exemplary embodiment.

FIG. 13 is a lower perspective view of a front sub frame coupled to a container according to an exemplary embodiment.

FIG. 14 is a detailed view of a load cell coupled to a container and frame rails of a sub assembly according to an exemplary embodiment.

FIG. 15 is a perspective view of a loading area for a vehicle container according to an exemplary embodiment.

FIG. 16 is a side view of a loading area for a vehicle comprising a compaction system in an extended position according to an exemplary embodiment.

FIG. 17 is a side view of a loading area for a vehicle comprising a compaction system in an insertion position according to an exemplary embodiment.

FIG. 18 is a side view of a loading area for a vehicle comprising a compaction system in scooping position according to an exemplary embodiment.

FIG. 19 is a side view of a loading area for a vehicle comprising a compaction system in compaction position according to an exemplary embodiment.

### DETAILED DESCRIPTION

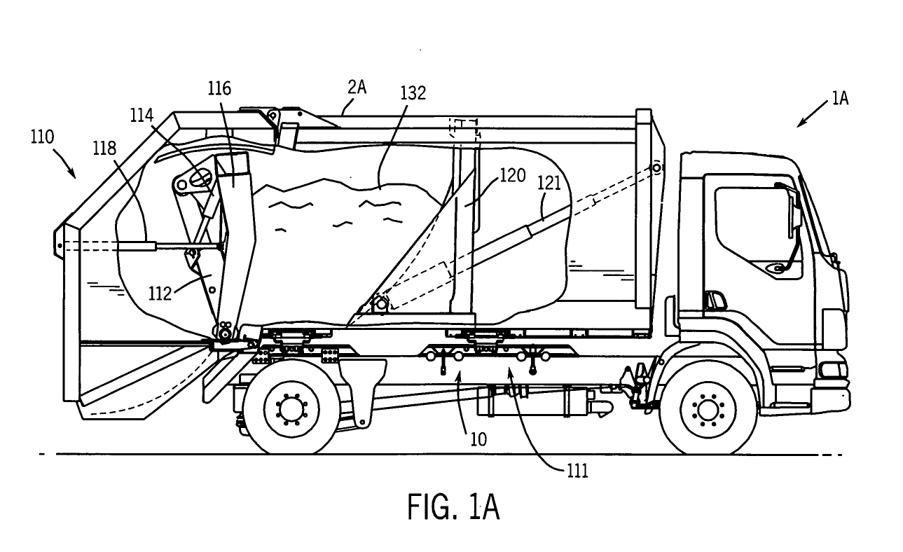

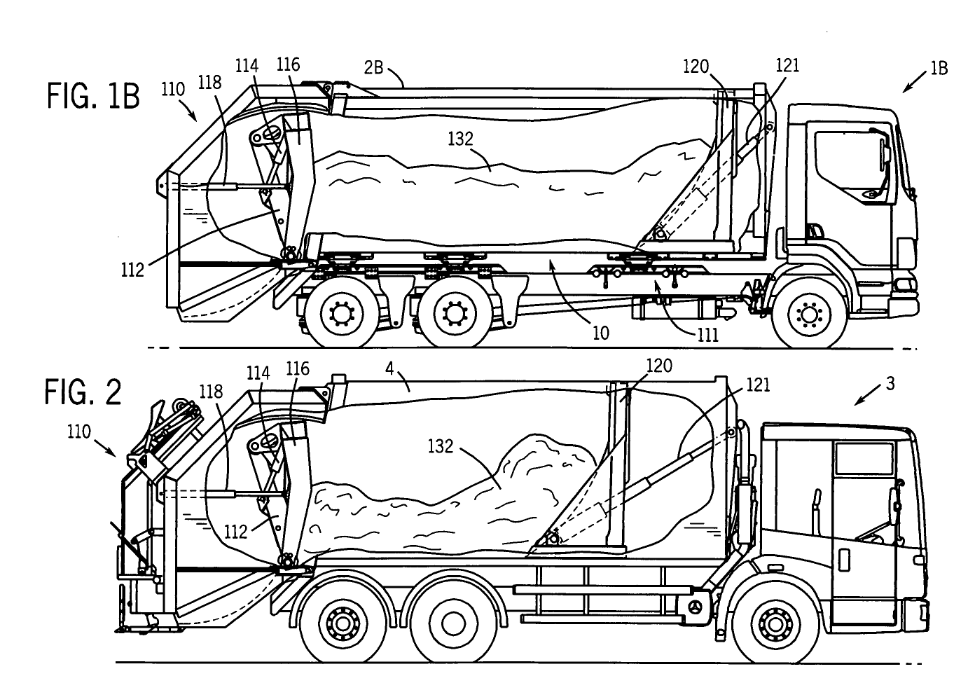

In general, the universal mounting system described in this disclosure comprises a sub frame assembly for attaching a material container to different vehicles each having a first and second generally parallel chassis member. The sub frame is intended to be configured for use with different vehicles having different spacings (e.g., chassis widths). According to various embodiments, the mounting system is intended to be used with any suitable vehicle used for container handling applications. For example, the mounting system may be used with cement trucks, waste hauling trucks (e.g., garbage trucks), dump trucks, tanks, etc. Typically, the vehicles comprise a plurality of axles and wheel assemblies. In addition, the vehicles generally include a motor coupled to the one or more of the axles for driving the axles. Similarly, the universal mounting system described herein is intended to be used with a wide variety of containers attachable to the vehicles by way of the mounting system. According to various exemplary embodiments, any suitable container may be used with the mounting system including roll-off containers, dump truck containers, waste hauling containers (e.g., for garbage), waste hauling boxes, etc. FIGS. 1A, 1B and 2 provide examples of different types of vehicles 1A, 1B and 3 and containers 2A, 2B and 4 that may be used with the mounting, compaction and weighing systems of this disclosure (e.g., mounting system 10 including first and second sub frames 22, 24).

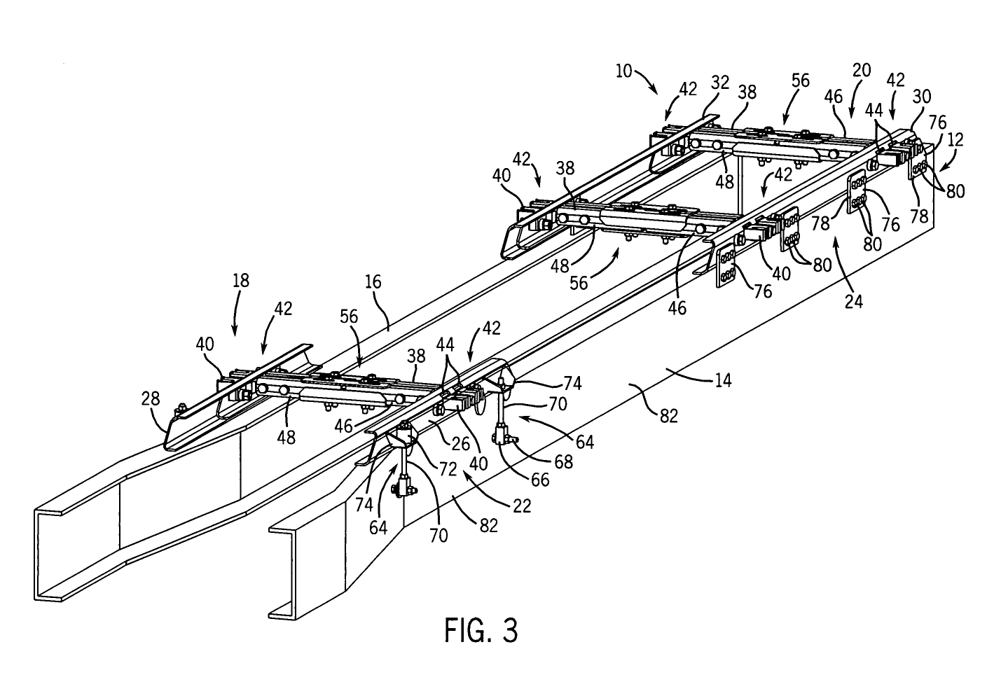

Referring to FIG. 3, a universal mounting system or assembly 10 is shown removably coupled to a chassis 12. Chassis 12 is shown having a first chassis member 14 and a second chassis member 16. First and second chassis members 14 and 16 are generally parallel to one another. Chassis 12 comprises a front end 18 (e.g., front) and a rear end 20 (e.g., rear). System 10 includes a first sub frame 22 positioned proximate front end 18 and a second sub frame 24 positioned proximate rear end 20.

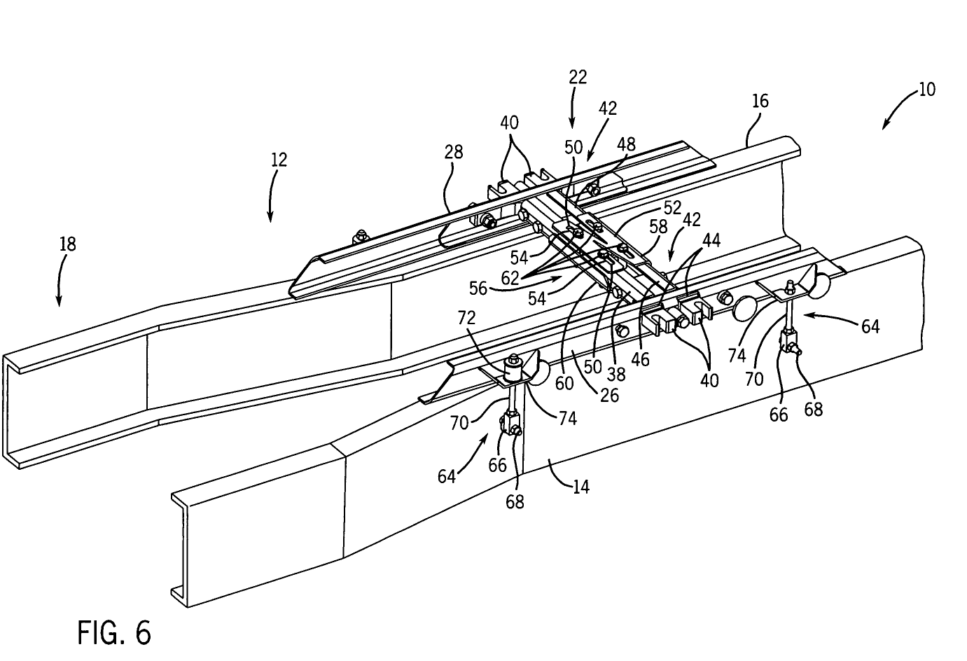

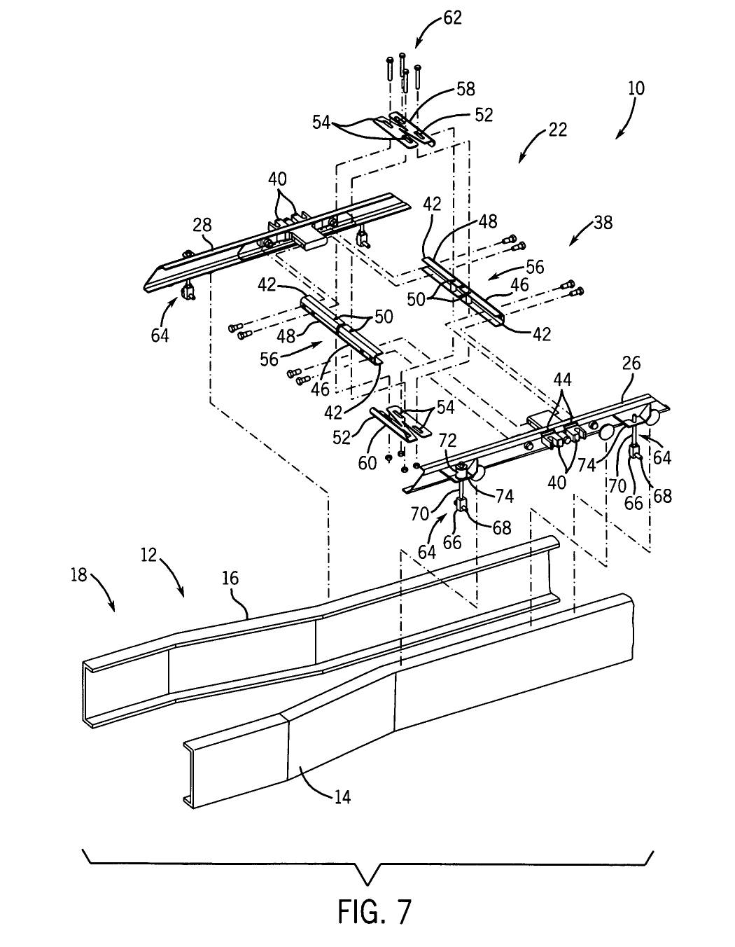

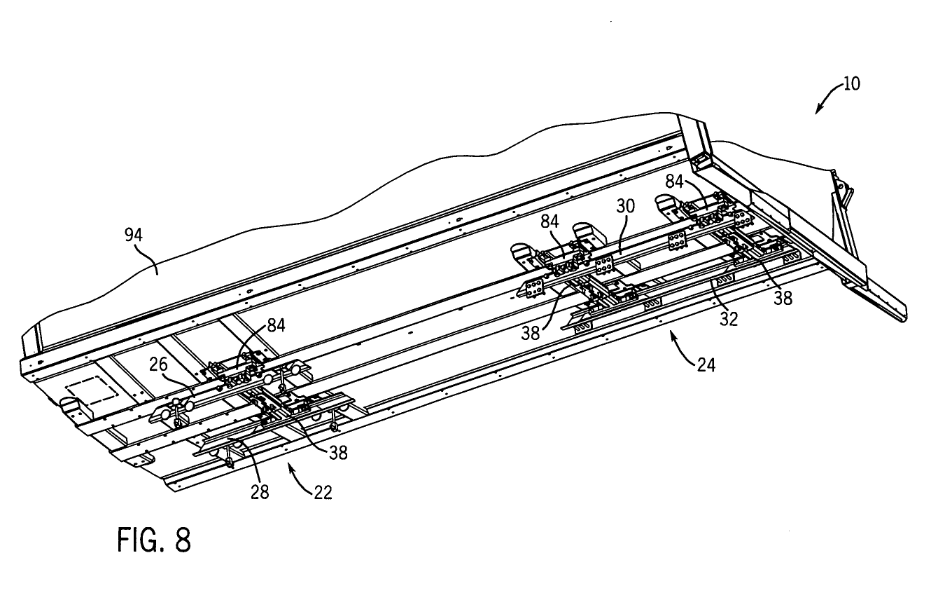

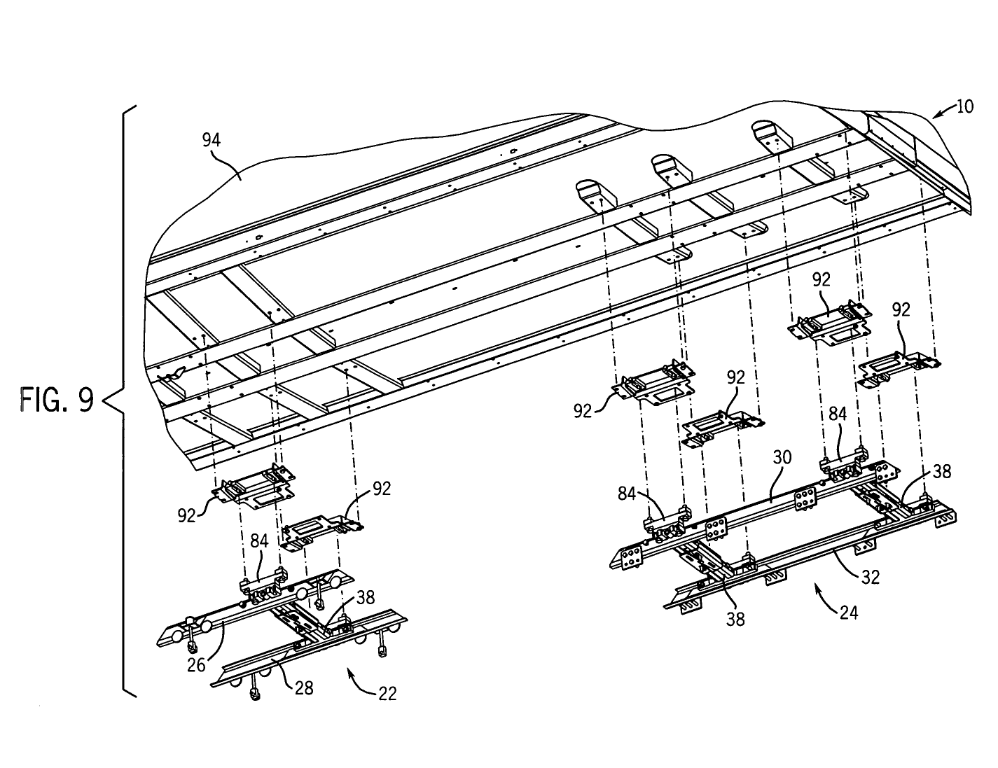

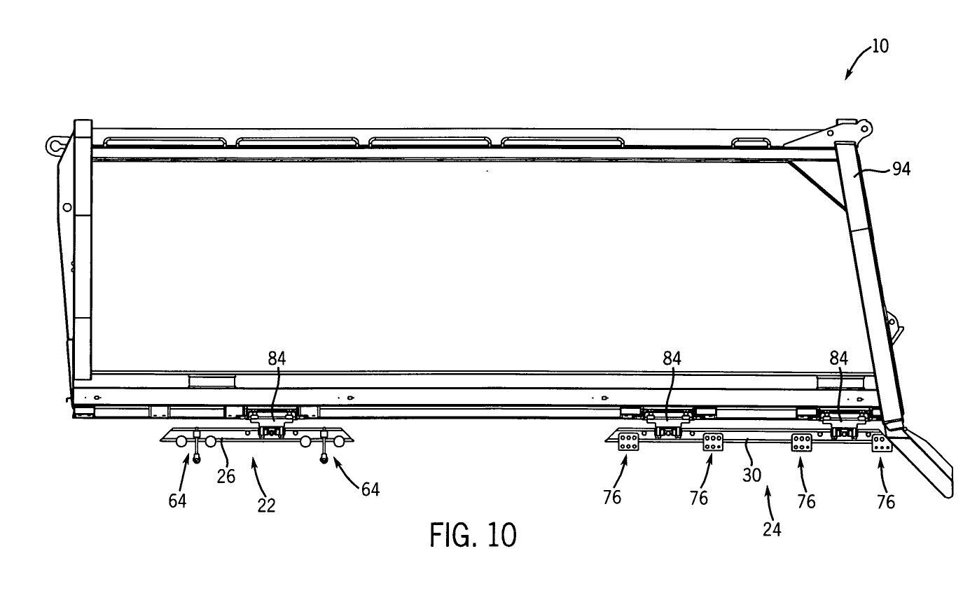

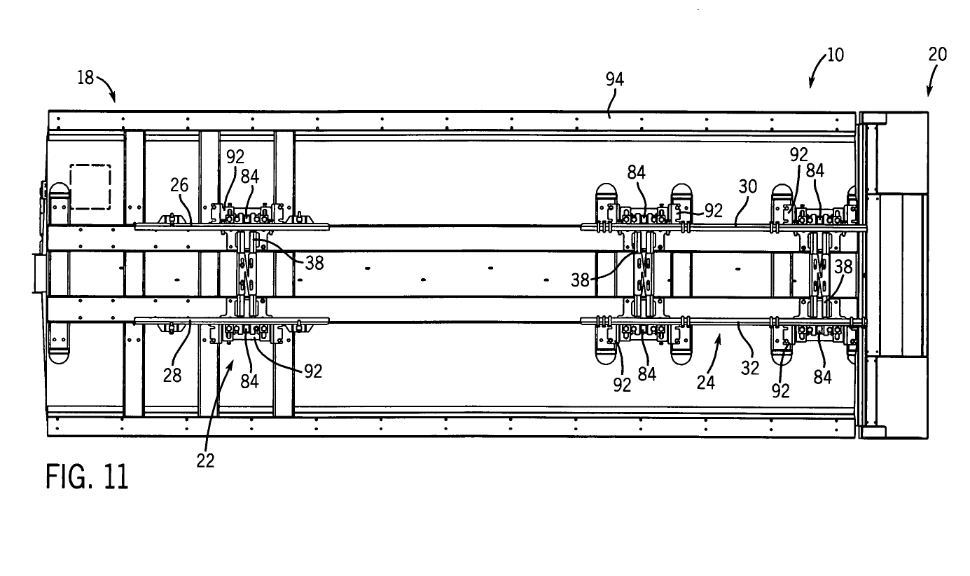

As shown in FIGS. 3, 6-11, and 13, first sub frame 22 comprises a first frame rail 26 and a second frame rail 28. Each of first frame rail 26 and second frame rail 28 are associated with each of first and second chassis members 14 and 16. First and second frame rails 26 and 28 are coupled to corresponding chassis members 14 and 16 at connectors 64. As best shown in FIGS. 6 and 7, connectors 64 each include a mount 66, a shaft 70, a bearing 72, and a support 74. Mounts 66 are coupled to an outer side 82 of chassis members 14 and 16 with fasteners 68. According to an exemplary embodiment, fasteners 68 comprise threaded fasteners (e.g., bolts, screws, etc.). Shafts 70 are rotatably coupled to mounts 66 and extend through an opening in supports 74. The portions of shafts 70 extending through supports 74 are coupled to bearings 72 to allow for some torsional movement of first sub frame 22 relative to chassis 12. This configuration allows for a flexible mounting of first sub frame 22 to chassis 12. According to various alternative embodiments, the supports may be coupled to the frame rails according to any suitable method. For example, the supports may be coupled to the frame rails by welding, adhesives, fasteners, etc.

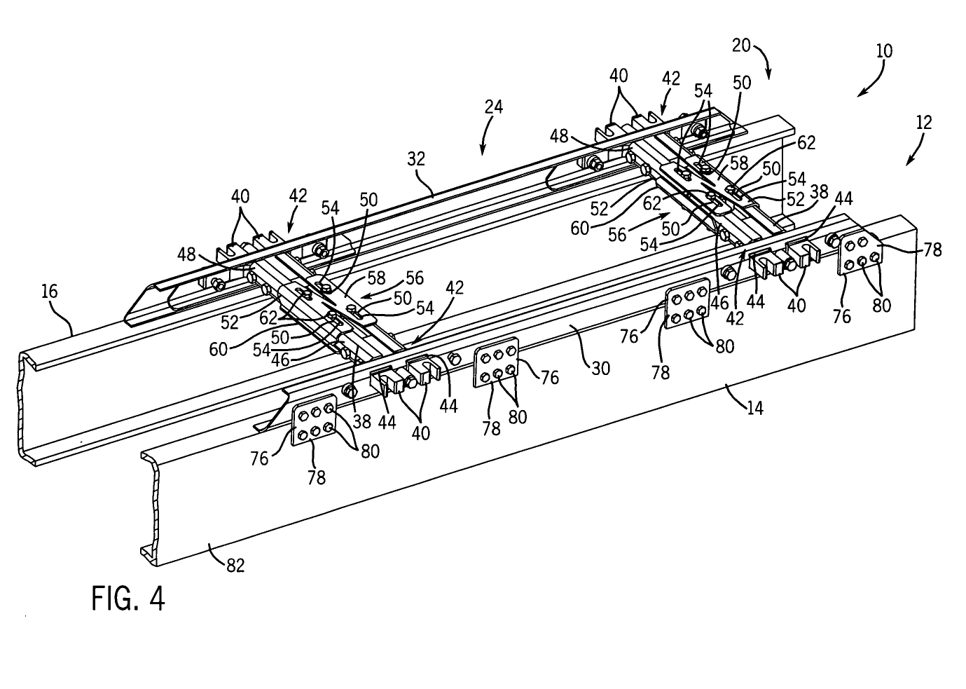

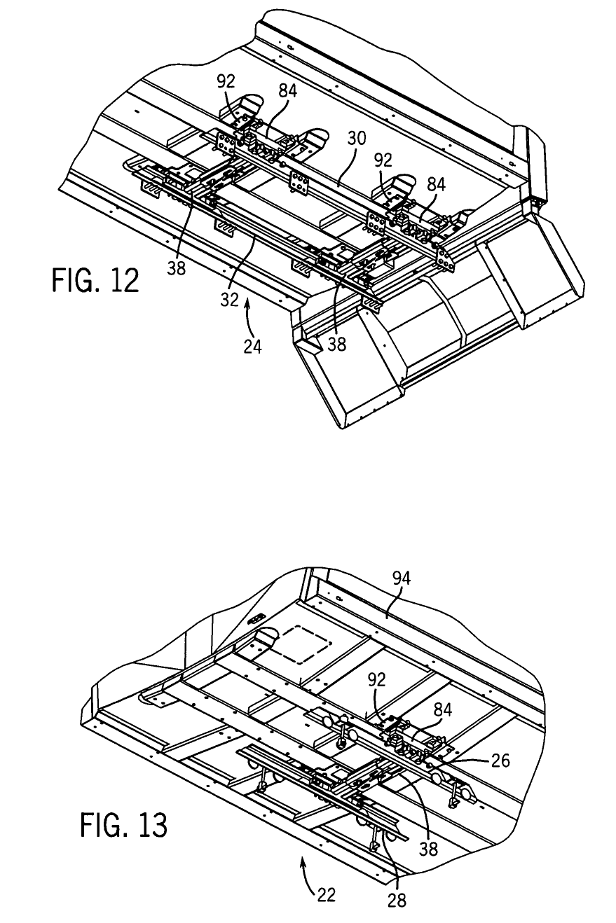

Referring to FIGS. 3, 4-5, and 8-12, second sub frame 24 includes a first frame rail 30 and a second frame rail 32. Each of first frame rail 30 and second frame rail 32 are associated with each of first and second chassis members 14 and 16. First and second frame rails 30 and 32 are coupled to corresponding chassis members 14 and 16 at connectors 76. Connectors 76 include substantially planar (e.g., flat) members 78 that are attached to an outer side 82 of chassis members 14 and 16 with fasteners 80. According to an exemplary embodiment, fasteners 80 comprise threaded fasteners (e.g., bolts, screws, etc.). According to various alternative embodiments, any suitable fastener, adhesive, and/or welding process may be used to attach connectors 76 to chassis members 14 and 16. Once connectors 76 are coupled to chassis members 14 and 16, members 78 are in position to make direct contact with first and second frame rails 30 and 32 to provide support to sub frame 24 and resist movement of sub frame 24 during operation of the vehicle.

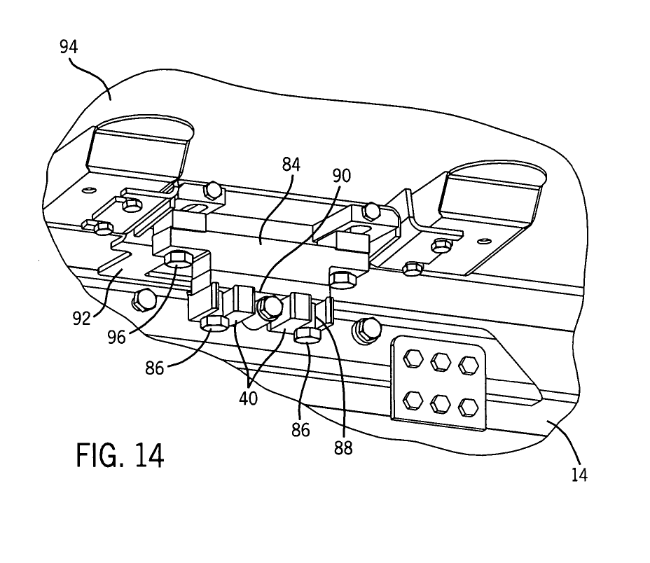

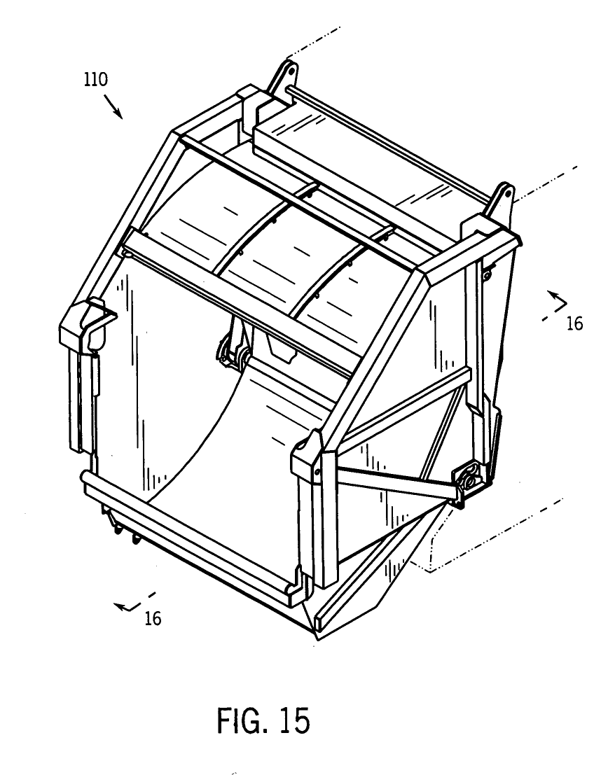

Referring to FIGS. 3-13, first sub frame 22 and second sub frame 24 comprise a plurality of cross members 38. According to an exemplary embodiment, first sub frame 22 comprises two cross members 38 and second sub frame 24 comprises four cross members 38. According to various alternative embodiments, any suitable number of cross members may be used. Cross members 38 are configured to hold frame rails 26, 28 and 30, 32 in a generally fixed relationship and adjustably space frame rails 26, 28 and 30, 32 at a distance which corresponds to the spacing of chassis members 14 and 16. Cross members 38 comprise mounts 40 supported on the outside of frame rails 26, 28 and 30, 32 at outboard ends 42 of cross members 38. Mounts 40 are intended to support and attach containers to vehicles used with system 10. According to an exemplary embodiment, mounts 40 are portions of respective cross members 38 which extend through respective frame rails 26, 28 and 30, 32 at openings 44. As best shown in FIG. 14, mounts 40 are U-shaped members and are arranged for attaching load cells 84 to a respective mount 40 and permit adjustment of a load cell 84 relative to its respective mount 40. The adjustability of mounts will be discussed in greater detail below.

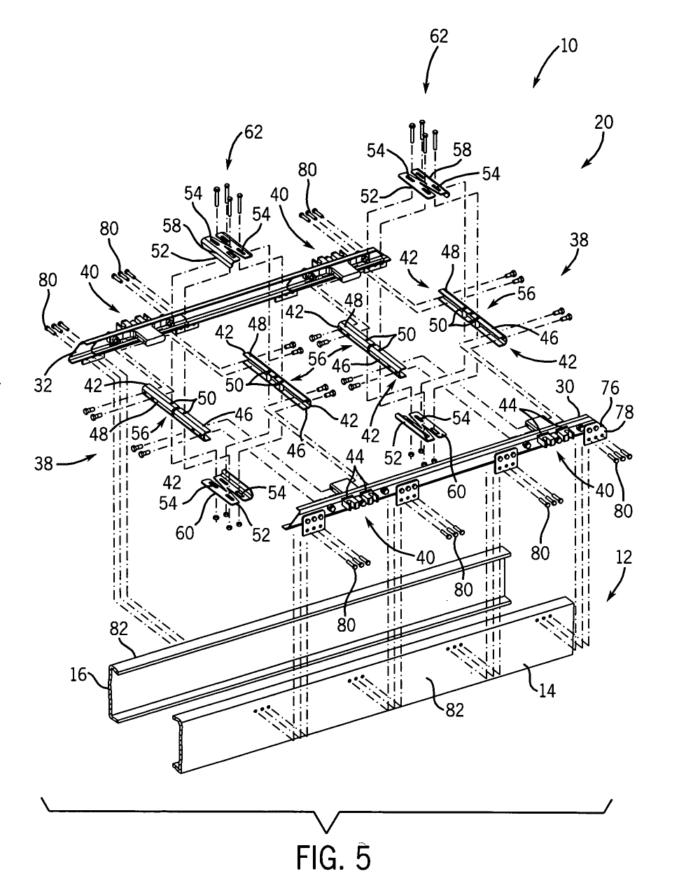

Referring to FIGS. 3-13, cross members 38 comprise portions 46 and 48 which are adjustable relative to one another. Being adjustable relative to one another allows portions 46 and 48 to adjust the distance between frame rails 26, 28 and 30, 32. Portions 46 and 48 are configured to be adjustable until a desired distance between frame rails 26, 28 and 30, 32 is obtained. Once the desired distance is established, portions 46 and 48 may be fixedly coupled relative to one another. As shown in FIGS. 5 and 7, portions 46 and 48 include apertures 50 configured to receive a fastener. Brackets 52, or the like, having slots 54 that correspond to apertures 50 of portions 46 and 48 are placed over ends 56 of portions 46 and 48. A first bracket 58 may be placed against an upper surface of portions 46 and 48 and a second bracket 60 may be placed against a lower surface of portions 46 and 48. First and second brackets 58 and 60 may also be rounded, curved, and/or bent at one or more corners thereby corresponding to the shape of portions 46 and 48. Once brackets 52 are placed over and/or against portions 46 and 48, apertures 50 of portions 46 and 48 and brackets 52 are aligned for receiving fasteners, such as bolts 62. Bolts 62 are placed into apertures 50 and 54 to fixedly couple portions 46 and 48 together. Bolts 62 may be tightened using nuts or the like. According to an exemplary embodiment shown in FIGS. 3 and 5, two portions 46 and two portions 48 are couple together to form cross member 38. According to various other exemplary embodiments, any number of portions may be used to form members 38. As shown in the FIGURES, ends 42 of portions 46 and 48 are fixedly coupled to frame rails 26, 28 and 30, 32. Bolts 62 engage various portions of frame rails 26, 28 and 30, 32, cross members 38, and/or other elements to fix them relative to one another. According to an exemplary embodiment, ends 42 are welded to frame rails 26, 28 and 30, 32 once mounts 40 are positioned through openings 44 of frame rails 26, 28 and 30, 32. According to another exemplary embodiment shown in FIGS. 3-7, ends 42 may be coupled to mounts 40 by way of fasteners (e.g., bolts) or the like. In addition to cross members 38, first sub frame 22 may also comprise cross bars for further support and positioning of first sub frame 22 relative chassis members 14 and 16. Additional cross bars may help absorb torsional loads applied to the system and maintain the generally rectangular shape of the sub frame mounting.

According to various alternative embodiments, any suitable means for adjusting the distance between the frame rails may be used. For example, other types of slidable portions may be utilized. According to an alternative embodiment, one portion or member may be configured to slide at least partially within the other portion or member. For example one member may slide within a channel formed in the other member until locked in place. According to an alternative embodiment, one member may be positioned entirely within the other member (e.g., a telescoping arrangement). The inner member may then be moved relative to the outer member until the desired configuration is obtained. The portions may then be fixed relative to one another by clamps, hooks, pins, etc. Similarly, one member may be slidably coupled to a track or glide (e.g., by way of a wheel, groove, etc.) for movement relative to a fixed member. Once the slidable member is positioned so that the frame rails are spaced at a desired distance, the slidable member can be locked in a fixed position according to any suitable means.

According to an exemplary embodiment as shown in FIG. 14, system 10 comprises load cell 84 which is configured to generate a signal representative of load applied by a container mounted on the vehicle. Load cell 84 is included as part of a load indication system 111 (as shown in FIGS. 1A and 1B) which comprises a plurality of electronic load cells 84. The load indication system 111 is coupled to a vehicle and is configured to measure the load on the vehicle. The load indication system 111 is operably connected to a control system to provide load information for controlling a hydraulic system for operation of the container. According to an exemplary embodiment, the load indication system 111 is configured to provide an indication of load on at least one axle and the total load on a rear loaded vehicle. According to alternative embodiments, any suitable type of vehicle may be used with the load indication system. For example, a vehicle having an adjustable sub frame, a constant width sub frame, etc. may be used. In general, the system may operate with a vehicle comprising a push-out panel 120 for generally emptying the container and compacting refuse against. The vehicle may also include a compacting mechanism or system 110 configured to compact refuse against the push-out panel 120. The vehicle may also be equipped with a lifting device for substantially emptying refuse bins into the container.

Referring to FIG. 14, load cell 84 is coupled to mounts 40 by way of fasteners 86. According to a preferred embodiment as shown in the FIGURES, fasteners 86 are bolts. According to various alternative embodiments, the fasteners may be any suitable attachment means (e.g., screws, clamps, hooks, etc.) Referring back to FIG. 14, fasteners 86 are threaded through mounts 40 and apertures 88 located on an undersurface 90 of cells 84. According to an exemplary embodiment, mounts 40 may be configured to include one or more attachment arrangements for attaching mounts 40 and permitting adjustment of each load cell 84 relative to a respective mount 40. Mounts 40 are at least partially adjustable so that cells 84 may be positioned according to the needs associated with a particular container and/or vehicle. For example, the mounts may be positioned to couple with the load cells at varying distances from the sides of the chassis members 14 and 16 (e.g., the mounts may adjustably extend generally outward in a substantially perpendicular direction to the outer surface of the chassis members). According to various alternative embodiments, the mounts may be adjusted in other directions other than in a substantially perpendicular direction to the outer surface of the chassis members (e.g., at an angle relative to the chassis). In addition, the fasteners may be adjusted and coupled to the mounts at different locations along the u-shaped apertures in the mounts. For example, the fasteners may be positioned near the curved surfaces of the u-shapes of the mounts as well as near the open portions of the u-shapes of the mounts.

As shown in FIG. 14, load cells 84 may be coupled to connectors 92 which are configured to couple with various containers. Connectors 92 include attachment arrangements for attaching the load cells to the container and permitting adjustment of each load cell relative to the container. As shown in FIG. 14, connectors 92 are coupled to container 94 by way of fasteners 96 (e.g., bolts, screws, etc.). According to various exemplary embodiments, the shape and configuration of the connectors, mounts and system may vary according to the different types of containers and vehicles used.

System 10 may be used with various vehicles and containers suitable for holding materials. Each sub frame 22 and 24 spread the load of the container over the chassis. Load cells 84 provide a means of determining the weight of the load from the materials held in the container in order to manage the overall forces applied to the chassis. Load cells 84 are intended to measure the load on one individual axel in addition to the overall load on the vehicle. As refuse is collected, the weight on the axle(s) and the chassis may be determined, thereby providing an indication of how much weight may still be loaded into the vehicle container. The placement of mounts 40 on the sides of chassis members 14 and 16 helps reduce the overall height of the system. For example, some conventional systems provide mounts on top of the chassis which can increase height and result in a higher center of gravity. The lower mounts help provide a lower center of gravity for the vehicles.

As described above, the vehicle includes a motor coupled to one or more axle and wheel assembly such that the motor is configured to drive the axle. In addition, the vehicle may comprise a control system and a hydraulic system having one or more hydraulic operators associated with various operations. The hydraulic system may be configured for lifting, tipping and/or compacting the collected refuse. The control system may include sensors and actuators to control the hydraulic system and activate the valves as needed. A variable displacement hydraulic pump may be coupled to the motor and a valve assembly may be included to couple the pump to the one or more hydraulic operators. The valve assembly is configured to automatically divert fluid flow from one of the operators to another of the operators when the power required by the operators exceeds the power amount which the pump can deliver when the motor is delivering the maximum power available form the motor to the pump.

The hydraulic system may further comprise a load dependent adjustable hydraulic system having a load dependent function that comprises a compaction operation and a counter pressure operation. The load dependent function is configured to control the hydraulics in a proportional mode to adjust refuse density in the container to prevent overloading of an axle. By connecting the control system and the load indication system, the push-out panel (as shown in FIGS. 1A, 1B and 2) may be moved toward the front of the container when the load indication system detects too much weight over an axel (e.g., rear axel). The push-out panel is configured to move toward the front of the container so that the center of gravity of the collected refuse is moved toward the front of the container thereby relieving the load on the overloaded axel. According to various exemplary embodiments, the motor may be combustible, electrical, etc.

FIGS. 15 through 19 illustrate the operation of a compaction system 110 according to an exemplary embodiment. Compaction system 110 may be used with the universal mounting system and load indication system described herein. Compaction system 110 may be attached (e.g., coupled, connected, etc.) to a rear area or section of a refuse collecting vehicle. According to an exemplary embodiment, system 110 comprises a compaction plate or member 112, compaction plate cylinders 114, member or yoke 116, and cylinders 118 (e.g., yoke cylinders). In addition, system 110 comprises a counter pressure or push-out panel 120 (as shown in FIGS. 1A, 1B and 2) that works in conjunction with the mounting system 10 discussed herein.

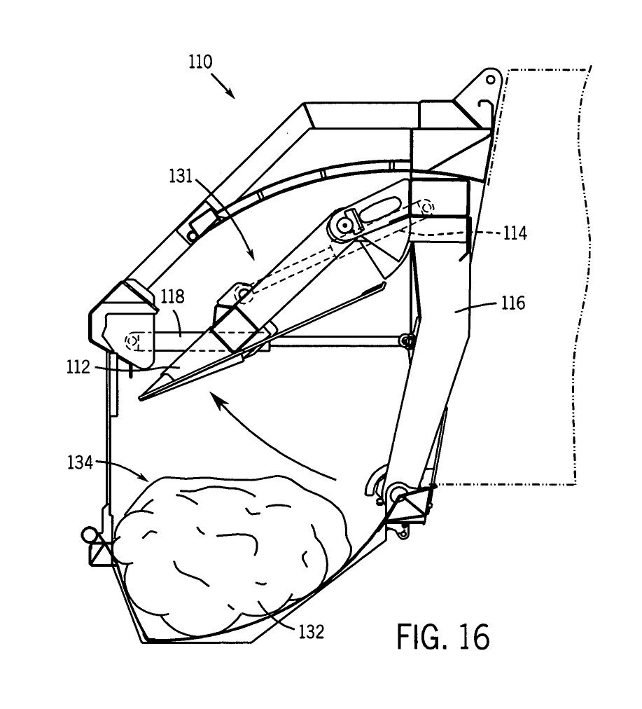

Referring to FIG. 16, compaction plate cylinders 114 are extended, thereby moving (e.g., pushing) compaction plate 112 upwards toward an upper section 131 of system 110. According to an alternative embodiment, the compaction plate may be moved to a desired location by any suitable means, including one or more cylinders, valves and/or other assemblies. Material (e.g., trash or rubbish) 132 is provided in a lower section 134 of system 110.

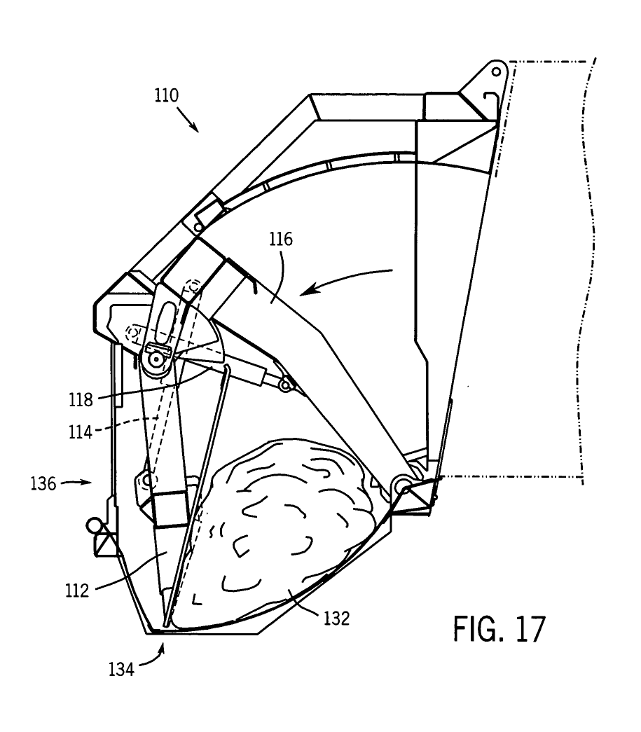

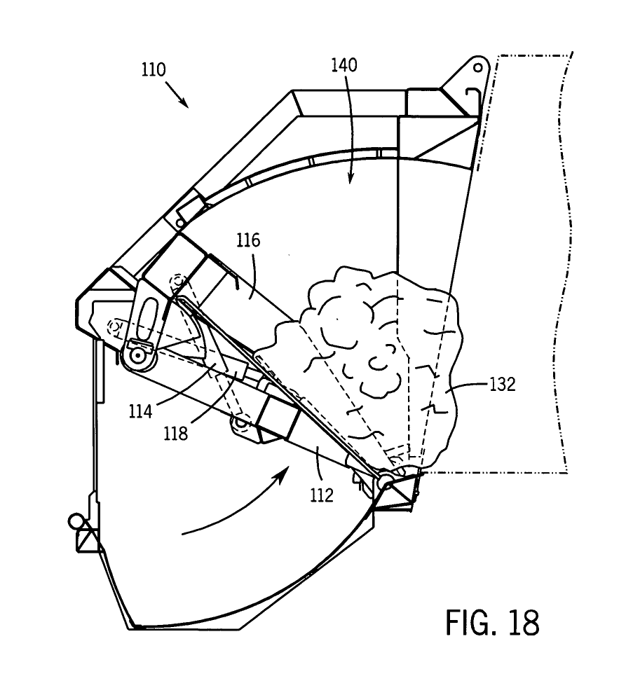

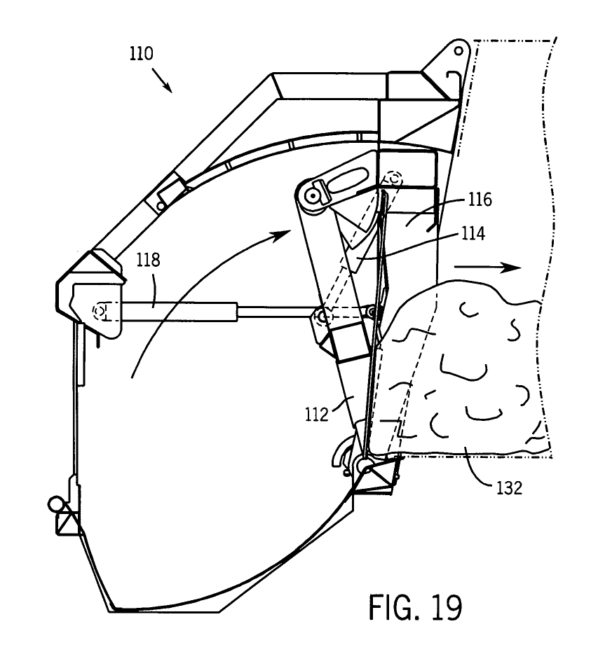

As shown in FIG. 17, yoke cylinders 118 pull yoke 116 backwards toward a rear section 136 of system 110. This allows compaction plate 112 to be positioned behind material 132. Referring to FIG. 18, compaction plate cylinders 114 then pull compaction plate 112 upwards toward upper section 140 of system 110 thereby pushing and/or pulling material 132 into the container of the vehicle (e.g., as shown in FIGS. 1A, 1B and 2). Referring to FIG. 19, yoke cylinders 118 push yoke 116 (and material 132) in a generally horizontal direction toward the cab of the vehicle (e.g., toward pressure or push-out panel 120). Load cells 84 generate signals representative of load applied by the material 132 in the container at various locations, including each axle. Depending on load characteristics and settings, the control system controls the hydraulic system for operation of the container and push-out panel 120. Hydraulic cylinders 121 control the position of push-out panel 120 based on the weight distribution of the material. According to an exemplary embodiment, the hydraulic cylinders are coupled to a front portion of the container and a portion of the push-out panel. Depending on the weight distribution, yoke cylinders 118 push material 132 to a desired location in the container and push-out panel 120 (controlled by hydraulic cylinders 121) provides sufficient counter-pressure against the force applied by yoke cylinders 118 and material 132 to regulate the amount of weight applied to each axle. A balance of forces is obtained from measurements obtained by load cells 84. This type of balancing helps prevent a build-up of material at any undesired location in the container so that one or more axles are not overloaded at any given time.

According to various exemplary embodiments, the assemblies and components of the systems described herein may be constructed from various different materials. According to a preferred embodiment, the assemblies and components of the systems are constructed from materials that are durable and substantially non-corroding. For example, the various components may be made from metal, alloys, steel, composites, etc. In addition, various parts of the systems may be constructed and assembled as a single integrally formed piece or may be assembled and constructed from multiple parts.

It is important to note that the above-described embodiments are illustrative only. Although the system has been described in conjunction with specific embodiments thereof, those skilled in the art will appreciate that numerous modifications are possible without materially departing from the novel teachings and advantages of the subject matter described herein. For example, different types of fasteners may be used in addition to or instead of the bolts as described herein. In addition, the sub frames may couple to the chassis at different locations or according to different configurations. Further, any suitable number of sub frames may be used (e.g., one, three, five, etc.). Accordingly, these and all other such modifications are intended to be included within the scope of the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangements of the preferred and other exemplary embodiments without departing from the scope of the appended claims.

What is claimed is:

1. A refuse collecting vehicle comprising:
at least one driven axle and wheel assembly;
a motor coupled to the at least one axle for driving the at least one axle;
a chassis having chassis rails supported relative to the at least one axle;
a container attached to the chassis;
a control system which controls a hydraulic system for operation of the container; and
a load indication system coupled to the vehicle and configured to measure load of the vehicle, wherein the load indication system is operably connected to the control system to provide load information for controlling the hydraulic system for operation of the container.

2. The vehicle of claim 1, wherein the load indication system is configured to provide an indication of load on the at least one axle.

3. The vehicle of claim 2, wherein the load indication system comprises at least one electronic load cell configured to generate a signal representative of load applied to the at least one cell.

4. The vehicle of claim 3, wherein the vehicle is a rear loading vehicle.

5. The vehicle of claim 1, wherein the load indication system is a total weighing system mounted between the container and the chassis.

6. The vehicle of claim 5, wherein the load indication system comprises a plurality of electronic load cells configured to generate a signal representative of load applied to each cell, each of the load cells connecting the chassis to the container.

7. The vehicle of claim 6, wherein the vehicle is a rear loading vehicle.

8. The vehicle of claim 7, further comprising:
a push-out panel for at least one of generally emptying the container and compacting refuse against; and
a compacting mechanism configured to compact refuse against the push-out panel.

9. The vehicle of claim 8, wherein the push-out panel is coupled to a hydraulic cylinder that moves the push-out panel between a first position proximate the cab of the vehicle and a second position proximate a loading area of the vehicle.

10. The vehicle of claim 9, wherein the compacting mechanism comprises a compaction plate coupled to the container by way of a first member.

11. The vehicle of claim 10, wherein the compaction plate and the first member are configured to move material provided in the loading area of the vehicle into the container so that the material is pushed toward the push-out panel in a substantially horizontal direction in the container.

12. The vehicle of claim 8, wherein the hydraulic system comprises:
at least a first and second hydraulic operator with a respective first and second operation;
a variable displacement hydraulic pump coupled to the motor; and
a valve assembly which couples the pump to the hydraulic operators;
wherein the valve assembly is configured to automatically divert fluid flow from one of the operators to another of the operators when the power required by the operators exceeds the power amount which the pump can deliver when the motor is delivering a maximum power available from the motor to the pump.

13. The vehicle of claim 12, wherein the hydraulic system further comprises a load dependent adjustable hydraulic system having a load dependent function that comprises a compaction operation and a counter pressure operation, wherein the load dependent function is configured to control the hydraulic operators in a proportional mode to adjust refuse density in the container to prevent overloading of the at least one axle.

14. The vehicle of claim 13, wherein the vehicle comprises a lifting device for substantially emptying refuse bins into the container.

15. A system for attaching a material container to different vehicles and measuring a load on the vehicles, each of the vehicles having chassis members, the system comprising:
a hydraulic system configured to control operation of the material container;
a control system configured to control the hydraulic system; and
a load indication system configured to measure the load on the vehicles, wherein the load indication system is operably connected to the control system to provide load information for controlling the hydraulic system and material container.

16. The system of claim 15, further comprising a plurality of container mounts configured to couple the material container to the load indication system.

17. The system of claim 16, wherein the load indication system further comprises a plurality of electronic load cells configured to generate a signal representative of load applied to each cell, each of the load cells connecting a respective mount to the container.

18. The system of claim 17, further comprising attachment arrangements for attaching the load cells to the container and permitting adjustment of each load cell relative to the container.

19. The system of claim 18, further comprising attachment arrangements for attaching the load cells to their respective mounts and permitting adjustment of each load cell relative to their respective mounts.

20. The system of claim 19, wherein the hydraulic system comprises:
at least a first and second hydraulic operator associated with a respective first and second operation;
a variable displacement hydraulic pump coupled to a motor; and
a valve assembly which couples the pump to the hydraulic operators, wherein the valve assembly is configured to automatically divert fluid flow from one of the operators to another of the operators when the power required by the operators 11 exceeds the power amount which the pump can deliver when the motor is delivering a maximum power available from the motor to the pump.

21. The vehicle of claim 20, wherein the hydraulic system further comprises a load dependent adjustable hydraulic system having a load dependent function that comprises a compaction operation and a counter pressure operation, wherein the load dependent function is configured to control the hydraulic operators in a proportional mode to adjust refuse density in the container to prevent overloading of the at least one axle.

22. A load indication system configured to couple to a vehicle and measure the load of the vehicle, the system comprising:
a sensor for generating a signal representative of the load of the vehicle;
a hydraulic system comprising a first and second hydraulic operator with a respective first and second operation;
a variable displacement hydraulic pump coupled to a motor; and
a valve assembly which couples the pump to the hydraulic operators;
wherein the valve assembly is configured to automatically divert fluid flow from one of the operators to another of the operators when the power required by the operators exceeds the power amount which the pump can deliver when the motor is delivering a maximum power available from the motor to the pump; and
wherein the sensor is operably connected to the control system to provide load information for controlling the hydraulic system for operation of the container.

23. The system of claim 22 wherein the sensor is configured to provide an indication of load on an axle of the vehicle.

24. The system of claim 22 wherein a load cell comprises the sensor.

25. The system of claim 22 wherein the hydraulic system further comprises a load dependent adjustable hydraulic system having a load dependent function that comprises a compaction operation and a counter pressure operation, wherein the load dependent function is configured to control the hydraulic operators in a proportional mode to adjust refuse density in the container to prevent overloading of the at least one axle.

26. A method for attaching a material container to different vehicles and measuring load on the vehicles, each of the vehicles having chassis members, the method comprising:
providing a hydraulic system configured to control operation of the material container;
providing a control system to control the hydraulic system, the control system comprising a load indication system having a plurality of electronic load cells;
configuring the load indication system to measure the load on the vehicles by operably connecting the load indication system to the control system to provide load information for controlling the hydraulic system and material container;
providing a plurality of container mounts configured to couple the material container to the load indication system; and
configuring the load cells to generate a signal representative of load applied to each cell, each of the load cells configured to connect a respective mount to the container.

27. The method of claim 26, further comprising providing attachment arrangements for attaching the load cells to the container and permitting adjustment of each load cell relative to the container.

28. The method of claim 27, further comprising providing attachment arrangements for attaching the load cells to their respective mounts and permitting adjustment of each load cell relative to their respective mounts.

29. The method of claim 28, further comprising providing a container for material and configuring the container to attach to the load cells.

30. The method of claim 29, further comprising providing a vehicle having a chassis and a motor, the chassis being coupled to the load cells by way of the mounts.

31. The method of claim 30, further comprising configuring the hydraulic system to comprise:
at least a first and second hydraulic operator associated with a respective first and second operation;
a variable displacement hydraulic pump coupled to the motor; and
a valve assembly which couples the pump to the hydraulic operators, wherein the valve assembly is configured to automatically divert fluid flow from one of the operators to another of the operators when the power required by the operators exceeds the power amount which the pump can deliver when the motor is delivering a maximum power available from the motor to the pump.

32. The method of claim 31, further comprising configuring the hydraulic system to further include a load dependent adjustable hydraulic system having a load dependent function that comprises a compaction operation and a counter pressure operation, wherein the load dependent function is configured to control the hydraulics in a proportional mode to adjust refuse density in the container to prevent overloading of the at least one axle.

33. A compaction system for a material collecting vehicle having a loading area where material is collected and a container for holding the material, the compaction system comprising:
a compaction plate coupled to a first member; and
a second member pivotally coupled to the first member and pivotally coupled to the loading area;
wherein a first hydraulic cylinder is coupled to the first member and the second member;
wherein a second hydraulic cylinder is coupled to the second member and the loading area; and
wherein the first and second hydraulic cylinders control movement of the first and second members so that the material can be moved from the loading area to the container.

34. The system of claim 33 wherein the second hydraulic cylinder is configured to move the second member between a first position proximate a rear section of the container and a rear section of the loading area.

35. The system of claim 34 wherein the first hydraulic cylinder is configured to move the first member between a third position proximate the rear section of the loading area and a fourth position proximate the rear section of the container.

36. The system of claim 35 wherein the compaction plate is configured to move material provided in the loading area into the container so that the material is pushed toward the push-out panel in a substantially horizontal direction in the container.

37. The system of claim 36 wherein the loading area is coupled to a refuse container of a rear loading vehicle, the refuse container comprising a push-out panel controlled by at least one hydraulic cylinder for at least one of generally emptying the container and compacting refuse against.

38. The system of claim 37, further comprising a load dependent adjustable hydraulic system for controlling the hydraulic cylinders, wherein the hydraulic system has a load dependent function that comprises a compaction operation and a counter pressure operation, and wherein the load dependent function is configured to control the hydraulic cylinders in a proportional mode to adjust refuse density in the container to prevent overloading of one or sections of the container.
